(19) United States
(12) Patent Application Publication
(10) Pub. No.: US 2017/0354101 A1
(43) Pub. Date: Dec. 14, 2017

(54) Biodegradable Plant Mulch Device

(71) Applicant: Scott Prill, Hastings, MI (US)

(72) Inventor: Scott Prill, Hastings, MI (US)

(21) Appl. No.: 15/178,116

(22) Filed: Jun. 9, 2016

(51) Int. Cl. A01G 13/02

(52) U.S. Cl. CPC A01G 13/0281

(57) ABSTRACT

The invention is a completely biodegradable, bio-based plant and seedling mulching device that inhibits the growth of noxious weeds while allowing the flow of water to the root zone of the plant or seedling.

### CROSS-REFERENCES TO RELATED APPLICATIONS

Not applicable

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### Field of the Invention

This invention relates to the field of plant mulching systems and devices. It has advantages over current devices by being fully biodegradable in place, inexpensive to manufacture and composed entirely of bio-degradable polymers, fruits and vegetable materials.

### Description of the Prior Art

Since the beginning of recorded history farmers all over the world have faced the problems of keeping the roots of agricultural crops moist while preventing or discouraging the competing growth of noxious plants and weeds. This is accomplished most usually by covering the soil surrounding the desirable plants with materials that that block the sunlight to the competing noxious plants and weeds while allowing moisture to penetrate to the root zones of the desirable plants. The materials used range from organic materials such as straw and peat moss to inorganic plastic sheets. Non-commercial growers may even use at times old newspapers, but the leeching of inks into the soil is considered undesirable.

The most recent inventions use materials such nonwoven coconut fiber bound with latex. (For example, Boehringer U.S. Pat. No. 6,640,490 B1).

### BRIEF SUMMARY OF THE PRESENT INVENTION

The present invention is designed to prevent weed development surrounding plants or seedlings while channeling moisture toward the root system of the seedling. It is expected to be manufactured in various colors in order to enhance the growth of the seedlings by selectively reflecting portions of the light spectrum that are thought to be particularly beneficial to particular types of plants.

It consists of a single piece of biodegradable plastic which has a cut-out in the center, a slit running radially from the outer edge to the center cut-out to the outer perimeter of the device and a multiplicity of prong shaped areas arranged around the perimeter in a direction perpendicular to the surface of the device. It is intended to be placed nearly flat on the soil surface and a young vegetable or fruit plant is inserted by the user through the radial slit and buried in the soil in such a way that the leafy portion of the plant extends above the soil through the central cut-out. The surface of the device facing the air is slightly concave and is molded with grooves and ridges such that water falling on it is channeled toward the central cut-out. The pronged shaped areas are designed to be manually pushed into the soil to secure the device in place.

### DESCRIPTION OF THE SEVERAL VIEWS OF THE DRAWINGS

FIG. 1 is a perspective frontal view of the invention as disclosed in the preferred embodiment.

FIG. 2 is a perspective side view of the invention as disclosed in the preferred embodiment.

FIG. 3 is a plane top view of the invention.

FIG. 4 is another perspective side view of the invention.

### DETAILED DESCRIPTION OF THE INVENTION

The preferred embodiment of the invention is now described in detail. Referring to the drawings, like numbers indicate like parts throughout the views.

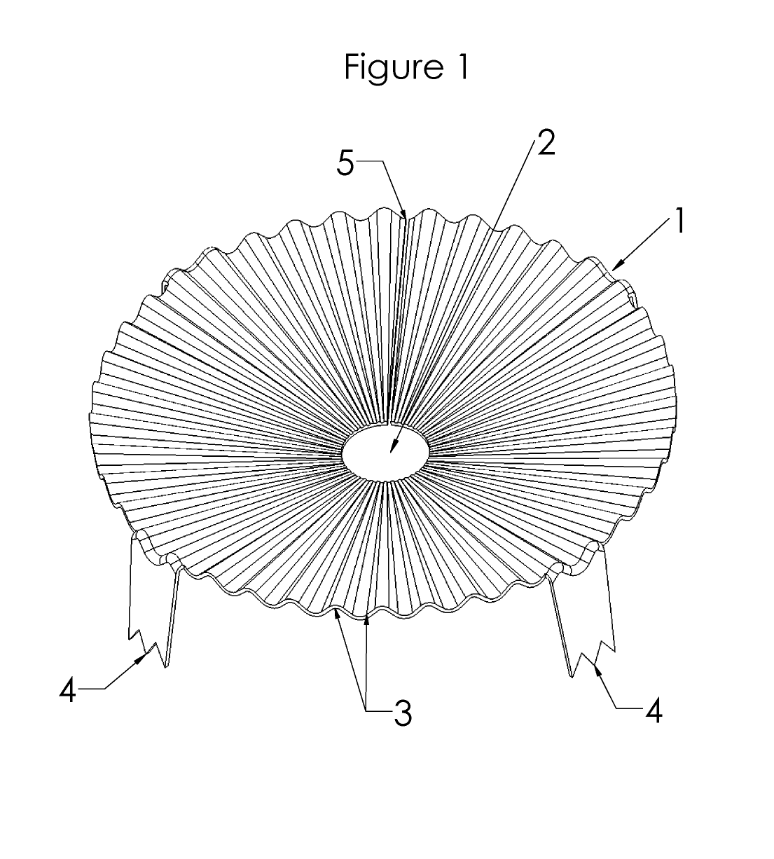

FIG. 1 shows the invention (1), the center cut-out (2), the ridges and valleys of the surface (3), two of the pronged perpendicular portions (4) and the slit (5) In the preferred embodiment the invention has four perpendicular prongs evenly spaced around the perimeter. In this embodiment the prongs (4) extend approximately 1½ inches below the valley bottoms of the surface.

The invention (1) in its preferred embodiment is approximately 8.5 inches measured straight across its surface diameter and approximately 0.0625 inches thick.

The central cut-out (2) is approximately 1.25 inches in diameter and is designed to allow the insertion of a plant seedling through the radial slit (5).

In this preferred embodiment, the invention (1) is formed with approximately forty ridges and thirty-nine valleys (3). The slit (5) is approximately 0.1 inches wide.

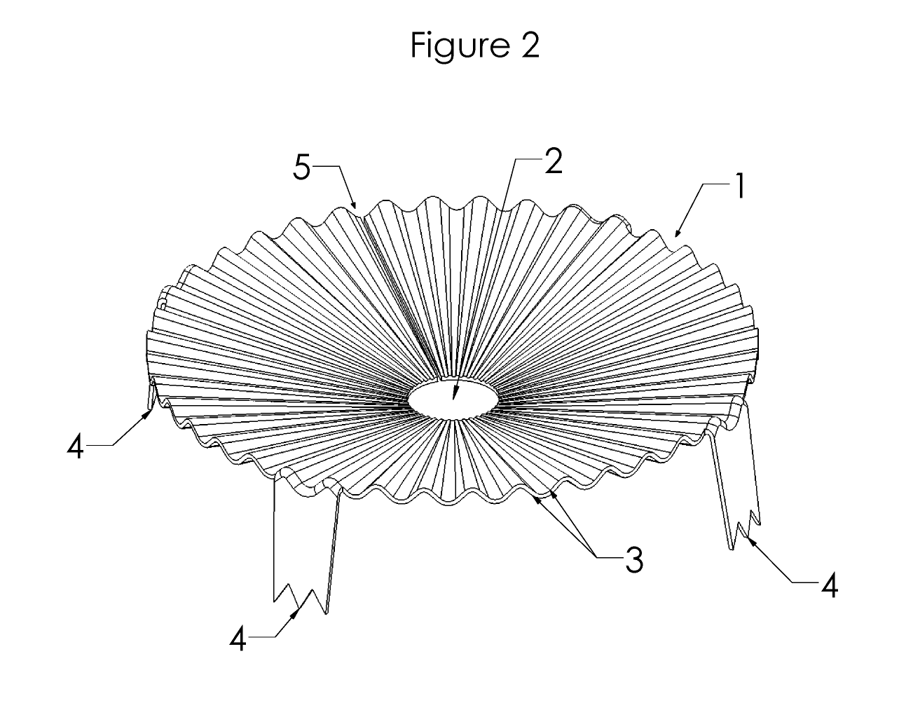

FIG. 2 shows three of the four prongs (4), the ridges and valleys (3) and the relative concavity of the invention. The bottom of the central cut-out (2) is approximately 0.75 inches below the outer perimeter of the invention (1). This shape channels any moisture falling on the invention through the center cut-out toward the root zone of the plant.

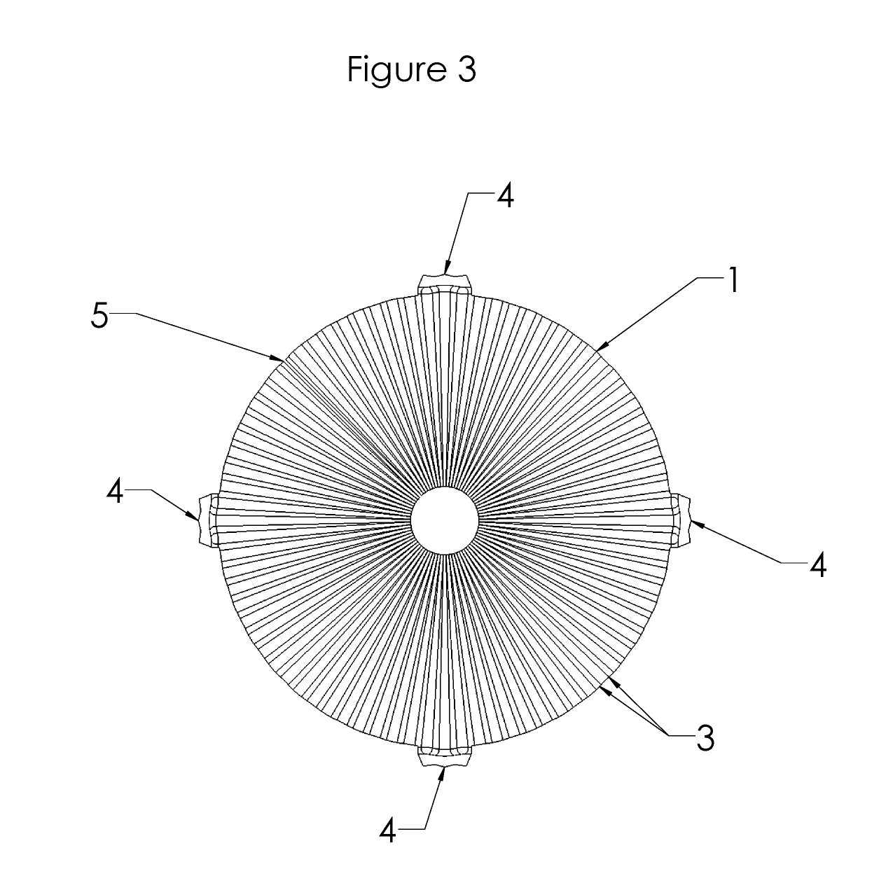

FIG. 3 shows the center cut-out (2), the ridges and valleys of the surface (3), location of the four pronged perpendicular portions (4) and the slit (5).

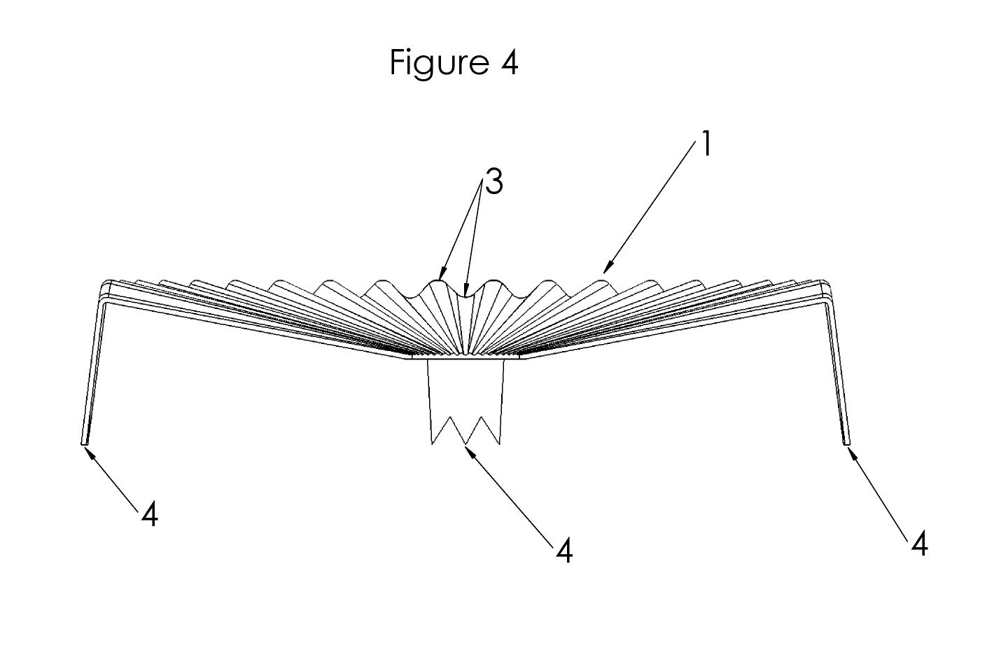

FIG. 4 shows more clearly the concavity of the device. In this perspective, only three of the four perpendicular pronged areas (4) are visible and the center cutout (2) is not visible.

The invention (1) is injection molded of a bio-degradable PHA bio-based polymer such as MIREL® manufactured by Metabolic, Inc. This material allows the user the choice of removing the invention at the end of the growing season and reusing it the next year or leaving it on the soil to decompose and be tilled back into the soil.

The above-described preferred embodiment is the best mode of the invention known to the inventor at the time of filing, but is given as illustrative example only. It will be readily apparent that many deviations in size and shape may be made from the specific embodiment disclosed in this specification without departing from the spirit and scope of this invention. For example, while the preferred embodiment is in the shape of a circular disk, it could be polygonal and still fall within the scope of this invention. Likewise, many deviations may be made from the specific material used to manufacture the invention without departing from the spirit and scope of this invention. The PHA-based polymer may be combined with suitably processed fruits and vegetables and fruit and vegetable scraps from the commercial food processing industry. Rather, the scope of the invention is to be determined by the claims below rather than being limited to the specifically described embodiments above.

What is claimed is:

1. A plant mulching device consisting of a suitably shaped form having a central hole and manufactured primarily of a bio-based, biodegradable polymer.

2. The device of claim 1 wherein the form is a circular concave shape with radial ridges and valleys and a radial slit connecting the central hole to the outer perimeter.

3. The device of claim 1 wherein suitably processed fruit and vegetables may be added to the biodegradable polymer up to approximately 60 percent of the material's total weight.
